(19) United States
(12) Patent Application Publication
(10) Pub. No.: US 2018/0096040 A1
(43) Pub. Date: Apr. 5, 2018

(54) DATA ANALYSIS INFORMATION PROCESSING DEVICE

(71) Applicant: Mitsubishi Electric Corporation, Tokyo (JP)

(72) Inventors: Takayoshi IIDA, Tokyo (JP); Yasuhiko TANAKA, Tokyo (JP)

(21) Appl. No.: 15/567,704

(22) PCT Filed: May 27, 2016
(86) PCT No.: PCT/JP2016/065794

§ 371 Date: Oct. 19, 2017

(30) Foreign Application Priority Data
Jun. 16, 2015 (JP) PCT/JP2015/067269

(51) Int. Cl. G06F 17/30

(52) U.S. Cl. CPC G06F 17/30572; G06F 17/30563

(57) ABSTRACT

A data analysis information processing device includes a database configured to store normalized data; a memory; an analysis instruction unit configured to specify and designate analysis target data, to be analyzed prior to other data, of the data before normalization; a normalization instruction unit configured to issue instructions to perform processing to normalize, prior to other data, the analysis target; a visualization instruction unit configured to issue instruction to perform processing to visualize, prior to other data, the analysis target data; a normalization processing unit configured to normalize, prior to other data, the analysis target data of the data before normalization; and a database processing unit configured to store the normalized data to the database, and to extract, prior to other data, data designated by the visualization instruction unit, and load the extracted data in the memory.

### TECHNICAL FIELD

The present invention relates to a data analysis information processing device that visualizes data stored in a database.

### BACKGROUND ART

As inexpensive computers are widespread and a sensor network environment can be constructed at low cost, for example, an environment in which a large amount of data can be collected and accumulated easily is maintained. As a method of extracting useful information from a huge set of collected data or a database, a data mining method has been known. Data mining is a method of visualizing data by using a computer, and with use of the visualized data, proceeding data analysis of an analysis target by a human interactively. For example, in an air-conditioning facility or the like, by monitoring the apparatus for a long period of time and analyzing the obtained data, the data may be utilized for optimization, abnormality detection, and the like of the apparatus. When analyzing data corresponding to such a long period of time, along with an increase in the amount of data, analysis speed drops significantly, so it takes a long time to complete the analysis. Regarding such a problem, Patent Literature 1 proposes a technology of individually analyzing data classified by each similar data type.

Meanwhile, in data analysis using a computer, it is necessary to perform normalization that converts the format of collected data into a format that a computer can handle easily, and database compilation to store data in which normalization is completed in a database. With appropriate processing by the computer, data is visualized, whereby data analysis can be performed easily.

### CITATION LIST

### Patent Literature

Patent Literature 1: Japanese Unexamined Patent Application Publication No. 2008-204282

### SUMMARY OF INVENTION

### Technical Problem

Even in the case of analyzing a large scale of data corresponding to a long period of time by a human with use of a computer, a large scale of data is normalized, and upon completion of the normalization, a database is compiled, and processing for visualization is performed. At that time, when performing data normalization and database compilation by a computer having an average processing performance, it takes a long time for the processing. As the data put in a database is visualized to be in a state where a human can begin data analysis, it is expected that an enormous amount of time is required until data analysis ends.

If a large amount of data can be processed at once, the processing speed of normalization and database compilation is expected to be improved. However, in order to improve the processing performance of a computer, there is no way other than using a plurality of computers or using an expensive computer. In the case of using a computer having an average processing performance, there is no choice but to take an enormous amount of time.

The present invention has been made to overcome the aforementioned problem. An object of the present invention is to provide a data analysis information processing device that enables reduction of the time taken until data analysis is completed even in the case of using a computer having an average processing performance.

### Solution to Problem

A data analysis information processing device according to an embodiment of the present invention includes: a database configured to store normalized data; a memory configured to store part of the data of the database; an analysis instruction unit configured to specify analysis target data, to be analyzed prior to other data, of data before normalization, and designate the analysis target data; a normalization instruction unit configured to issue instruction to perform processing to normalize, prior to other data, the analysis target data designated by the analysis instruction unit; a visualization instruction unit configured to issue instruction to perform processing to visualize, prior to other data, the analysis target data designated by the analysis instruction unit; a normalization processing unit configured to normalize, prior to other data, the analysis target data of the data before normalization; a database processing unit configured to store the data normalized by the normalization processing unit to the database, extracts, prior to other data, data designated by the visualization instruction unit from the database, and load the extracted data in the memory; and a display device configured to display the data loaded in the memory

### Advantageous Effects of Invention

According to an embodiment of the present invention, by adopting the above configuration, a normalization process and a visualization process of data are performed in parallel, and desired data is processed prior to other data as analysis target data. Thereby, the advantageous effect that visualization of the desired data is performed quickly in the case of using a computer of an average processing performance, is achieved.

### BRIEF DESCRIPTION OF DRAWINGS

FIG. 1 is a block diagram illustrating a data analysis information processing device according to Embodiment 1 of the present invention.

FIG. 2 is a flowchart explaining a normalization process performed by the data analysis information processing device of FIG. 1.

FIG. 3 is a flowchart explaining a visualization process performed by the data analysis information processing device of FIG. 1.

FIG. 4 is a schematic diagram illustrating an analysis setting screen of the data analysis information processing device of FIG. 1.

FIG. 5 is a schematic diagram (part 1) illustrating an analysis screen of the data analysis information processing device of FIG. 1.

FIG. 6 is a schematic diagram (part 2) illustrating an analysis screen of the data analysis information processing device of FIG. 1.

FIG. 7 is a schematic diagram (part 3) illustrating an analysis screen of the data analysis information processing device of FIG. 1.

FIG. 8 is a schematic diagram (part 4) illustrating an analysis screen of the data analysis information processing device of FIG. 1.

FIG. 9 is a block diagram illustrating a data analysis information processing device according to Embodiment 2 of the present invention.

FIG. 10 is a flowchart explaining a normalization process performed by the data analysis information processing device of FIG. 9.

FIG. 11 is a schematic diagram illustrating an analysis setting screen of the data analysis information processing device of FIG. 9.

FIG. 12 is a schematic diagram illustrating a priority instruction screen of the data analysis information processing device of FIG. 9.

FIG. 13 is schematic diagram illustrating an analysis screen of the data analysis information processing device of FIG. 9.

FIG. 14 is a block diagram illustrating a data analysis information processing device according to Embodiment 3 of the present invention.

FIG. 15 is a block diagram illustrating a data analysis information processing device according to a modification of Embodiment 3 of the present invention.

FIG. 16 is a schematic diagram illustrating an analysis screen of a data analysis information processing device according to Embodiment 4 of the present invention.

FIG. 17 is a schematic diagram (part 5) illustrating an analysis screen of a data analysis information processing device according to Embodiment 5 of the present invention.

FIG. 18 is a schematic diagram illustrating an analysis setting screen of a data analysis information processing device according to Embodiment 6 of the present invention.

FIG. 19 is a schematic diagram illustrating a priority designation screen of the of the data analysis information processing device according to Embodiment 6 of the present invention.

### DESCRIPTION OF EMBODIMENTS

Hereinafter, embodiments of a data analysis information processing device according to the present invention will be described in detail with reference to the drawings. It should be noted that the present invention is not limited to the embodiments.

A data analysis information processing device according to the present invention is used for analyzing a large amount of data. For example, it is used for continuously acquiring data regarding operation status of a plurality of air-conditioning apparatuses in an air-conditioning facility for a long period of time, and analyzing the data. Hereinafter, description will be given on the case of using a data analysis information processing device for data analysis of an air-conditioning facility.

### Embodiment 1

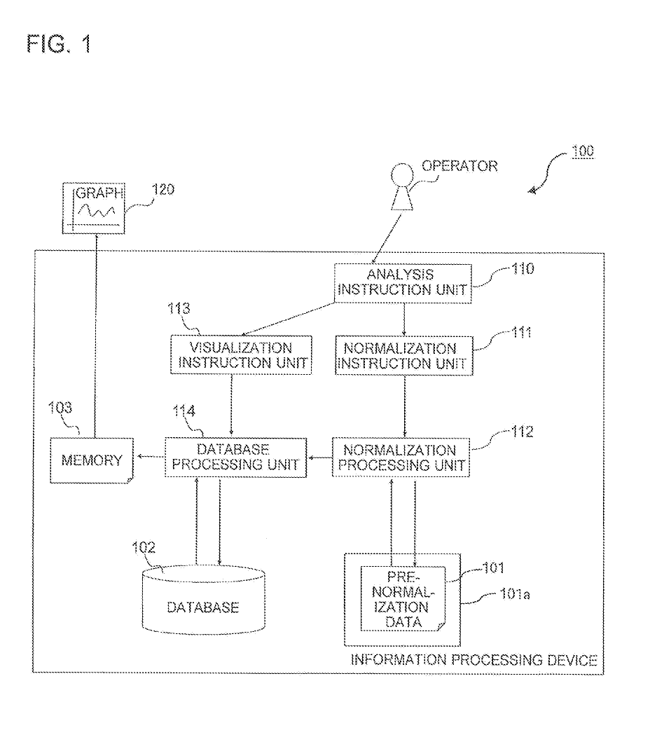

FIG. 1 is a block diagram illustrating a data analysis information processing device 100 according to Embodiment 1 of the present invention. As illustrated in FIG. 1, the data analysis information processing device 100 includes a memory 101a in which pre-normalization data 101 is stored, a database 102, and a memory 103, when attention is paid to storage devices.

The pre-normalization data 101 stored in the memory 101a includes temperature data, barometric pressure data, operation status data of the air-conditioning apparatus, and the like, for example, and is stored by each item along with data acquisition date and data of an air-conditioning apparatus that is a target of measurement. The database 102 is a region for storing data after normalization, and the memory 103 functions as a primary buffer for visualizing data on a display screen.

The data analysis information processing device 100 further includes an analysis instruction unit 110, a normalization instruction unit 111, a normalization processing unit 112, a visualization instruction unit 113, a database processing unit 114, and a display device 120. The data analysis information processing device 100 is realized by a program stored in a memory not illustrated, and a CPU (Central Processing Unit) executing it.

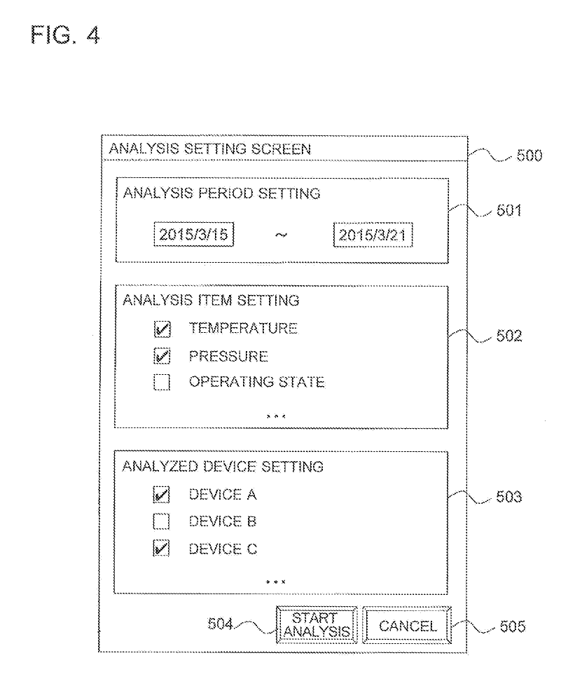

The analysis instruction unit 110 specifies an item input by an operator on the display screen (for example, analysis setting screen illustrated in FIG. 4) to be analyzed prior to other data as analysis target data, and notifies each of the normalization instruction unit 111 and the visualization instruction unit 113 of it, individually. For example, when “temperature” is input, the analysis instruction unit 110 specifies data related to temperature as analysis target data, and notifies the normalization instruction unit 111 and the visualization instruction unit 113 of it.

The normalization instruction unit 111 instructs the normalization processing unit 112 to process normalization of analysis target data that is to be normalized prior to other data, before instructing a process of normalizing the pre-normalization data 101 other than the analysis target data. Based on the instruction by the normalization instruction unit 111, the normalization processing unit 112 sequentially extracts data from the pre-normalization data 101 to normalize it, and gives the normalized data to the database processing unit 114 and stores it to the database 102 successively. At this time, the normalization processing unit 112 first normalizes data of the analysis target data designated by the normalization instruction unit 111, and then normalizes the pre-normalization data 101 other than the analysis target data sequentially. Normalization and storage of data by the normalization processing unit 112 is performed as a series of processing, and it is repeated until every pre-normalization data 101 is normalized during the time that the data analysis information processing device 100 is running.

Meanwhile, the visualization instruction unit 113 first instructs the database processing unit 114 to visualize the analysis target data based on the notification by the analysis instruction unit 110, and then issues instructions to visualize items other than that of the analysis target data. Based on such an instruction, the database processing unit 114 sets memory spaces corresponding to items of the analysis target data and those other than the analysis target data, and initializes them. Then, the database processing unit 114 sequentially extracts the normalized data from the database 102, and loads it on the memory 103. The display device 120 visualizes the normalized data in a graph, for example. The visualization process by the visualization instruction unit 113 is repeated periodically during the time that the data analysis information processing device 100 is running. When new data is normalized and stored in the database 102, it is visualized immediately, whereby the graph on the display device 120 is enriched.

As described above, as the analysis instruction unit 110 notifies each of the normalization instruction unit 111 and the visualization instruction unit 113 of an instruction individually, normalization of data by the normalization instruction unit 111 and visualization of data by the visualization instruction unit 113 are performed individually and in parallel.

Next, a normalization process performed by the data analysis information processing device 100 will be described with reference to a flowchart. When analysis begins, analysis target data is notified from the analysis instruction unit 110 to the normalization instruction unit 111.

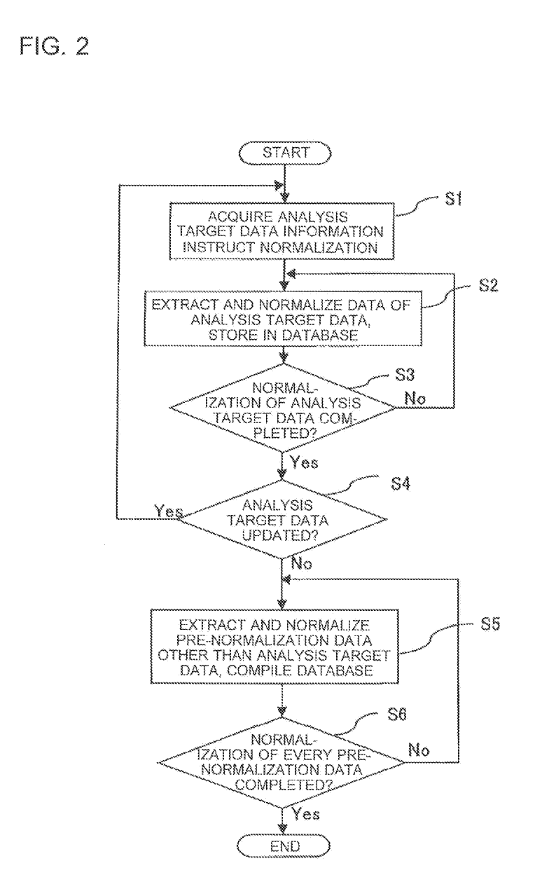

FIG. 2 is a flowchart explaining a normalization process performed by the data analysis information processing device 100 of FIG. 1. As illustrated in FIG. 2, when analysis target data that is data to be analyzed is notified from the analysis instruction unit 110, the normalization instruction unit 111 acquires information regarding the analysis target data, and instructs the normalization processing unit 112 to perform normalization (S1). Then, the normalization processing unit 112 extracts data corresponding to the analysis target data from the pre-normalization data 101, normalizes it, and stores it in the database 102 (S2). Then, the normalization instruction unit 111 determines whether or not normalization of whole of the data corresponding to the analysis target data is completed (S3). When it is not completed, the process returns to step S2, while when it is completed, the process moves to step S4. Next, the normalization instruction unit 111 determines whether or not the analysis correspondence data is updated (S4). When it is determined to be updated, the process returns to step S1, while when it is determined not to be updated, the process moves to S5. Next, the normalization instruction unit 111 extracts data other than the analysis target data from the pre-normalization data 101, normalizes it, and stores it in the database 102 (S5). Then, the normalization instruction unit 111 determines whether or not normalization of every pre-normalization data 101 is completed (S6). When it is not completed, the process returns to step S5, while when it is determined to be completed, the process ends.

As described above, the normalization process and database compilation are performed in a series of processing, and also data designated as analysis target data is normalized in priority to data other than the analysis target data.

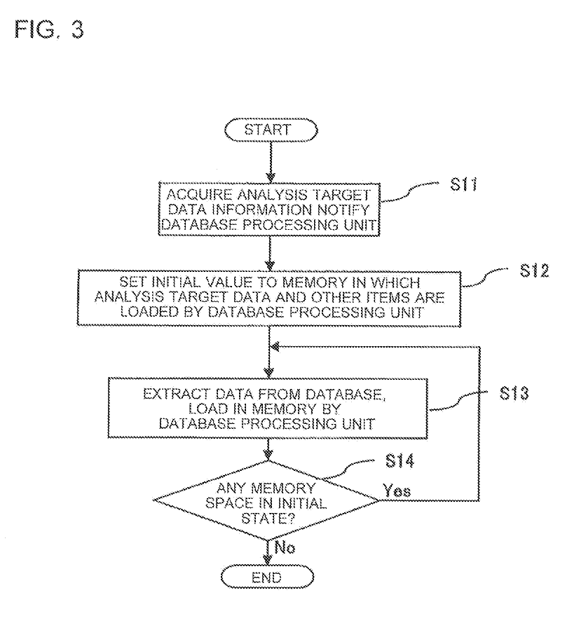

FIG. 3 is a flowchart explaining a visualization process performed by the data analysis information processing device 100 of FIG. 1. As illustrated in FIG. 3, when the analysis instruction unit 110 is notified of the analysis target data, first, the visualization instruction unit 113 acquires an instruction of the analysis target data from the analysis instruction unit 110, and notifies it to the database processing unit 114 (S11). Then, the database processing unit 114 sets, in an initial state, the memory spaces in which the analysis target data and items other than it are loaded (S12). Next, the database processing unit 114 extracts data stored in the database 102, and loads it in the memory 103 (S13). Then, the database processing unit 114 determines whether or not there is a memory space that is still set in the initial state (S14). When determining that there is one, the process returns to step 513, while when determining that there is none, the process ends.

Then, since data to be visualized, stored in the database, has been accumulated sequentially when the normalization process is completed, by performing the data visualization process, the data that the operator wishes to analyze prior to other data is visualized.

As described above, the normalization process and the visualization process are individually instructed by the analysis instruction unit 110, and the processes by the normalization instruction unit 111 and the visualization instruction unit 113 are performed simultaneously in parallel. Data that the operator wishes to analyze prior to other data is processed prior to other data. Therefore, the data that the operator wishes to analyze prior to other data, that is, the desired data, is visualized quickly.

Further, in the processes performed by the normalization instruction unit 111 and the visualization instruction unit 113, when the setting of the analysis target data is changed in the middle of performing the respective processes, the analysis target data is immediately reset at that time and the processes are restarted. At this time, the data of which normalization has been completed is held in a state of being stored in the database 102. Thereby, even when the operator changes the setting in the middle of the process, the data can be used for visualization instantly as required. Therefore, normalized data can be used effectively.

Next, a specific example of operation of the data analysis information processing device 100 will be described.

FIG. 4 is a schematic diagram illustrating an analysis setting screen 500 constituting a part of the analysis instruction unit 110 of the data analysis information processing device 100 of FIG. 1. As illustrated in FIG. 4, the analysis setting screen 500 is configured of a touchscreen on which analysis period setting 501, analysis item setting 502, analyzed device setting 503, and the like to which designated contents are input, and an analysis start button 504 are provided. The operator inputs analysis contents, and presses the analysis start button 504 to perform analysis. The analysis setting screen 500 may also be provided with a cancel button 505 and other designation contents. The number of items is not limited. Further, those other than a touchscreen are also applicable.

The operator designates analysis target data that the operator wishes to analyze prior to other data, on the analysis setting screen 500. For example, as designated contents, “2015/3/15˜2015/3/21” is set in the analysis period setting 501, “temperature” and “pressure” are designated in the analysis item setting 502. Further, “device A” and “device C” are designated in the analyzed device setting 503.

When the analysis start button is pressed in this state, aforementioned processes of the flowcharts of FIGS. 2 and 3 are performed. This means that by the analysis instruction unit 110, data corresponding to the information designated in the analysis period setting 501, the analysis item setting 502, and the analyzed device setting 503 is notified to the normalization instruction unit 111 and the visualization instruction unit 113 as information regarding the analysis target data. Thereby, the normalization instruction unit 111 starts normalization of the analysis target data, and the visualization instruction unit 113 instructs visualization of the analysis target data. It should be noted that the visualization instruction unit 113 issues instructions to set display of selected items and a range of the display period and the like, as an initial state.

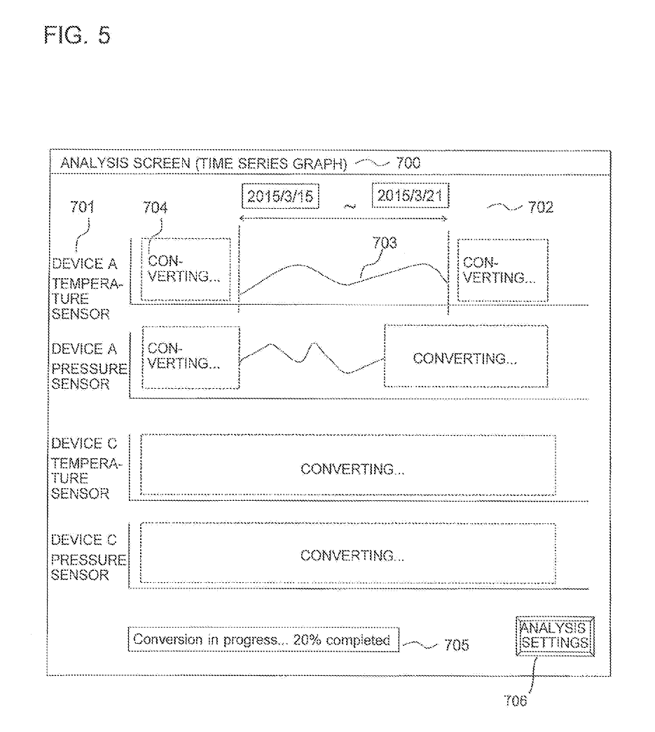

FIG. 5 is a schematic diagram (part 1) illustrating an analysis screen 700 of the display device 120 of the data analysis information processing device 100 of FIG. 1. As illustrated in FIG. 5, visualized analysis target data is displayed on the analysis screen 700 in devices and sensors information 701, and a time-series line graph showing an analysis period 702, and the like, for example. When the analysis start button 504 is pressed on the analysis setting screen 500, data is normalized and sequentially put into a database sequentially, and the data in the database is successively loaded in the memory 103 and displayed. At this time, in the database 102, analysis target data, having been normalized prior to other data, is stored.

Immediately after the start of analysis, there is no normalized data. Accordingly, a memory space is set in the initial state, and a message 704 such as “Converting . . . ” is displayed. When analysis is started, first, analysis target data is displayed. Then, when the display content is updated, the graph 703 is displayed step by step every time. Finally, whole of the data is visualized. The analysis screen may include a progress indicator 705 showing the ratio of the data having been shown in a graph, such as “converting . . . xx % completed”, for example. Thereby, the operator is able to recognize the percentage of conversion as a numerical value. Accordingly, compared with the case of visually recognized only from a graph, the convenience of the operator is improved.

While the operator is able to wait until every designated data is displayed, the operator is also able to end the display at the time when the analysis result is acquired. Further, even when the analysis is not completed, it is possible to press the analysis designation button 706 to designate new data as analysis target data, and to start analysis. In that case, a configuration is applicable in which a new item on the analysis setting screen 500 is selected, and new analysis is started by pressing the analysis start button 504 again, for example.

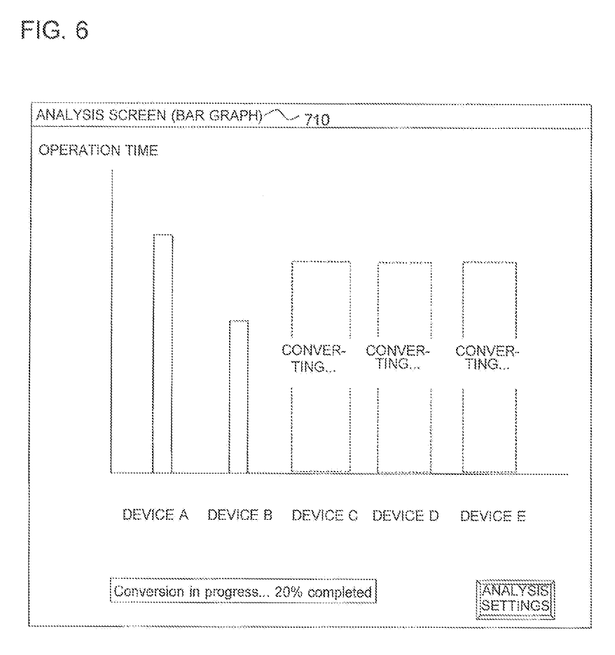

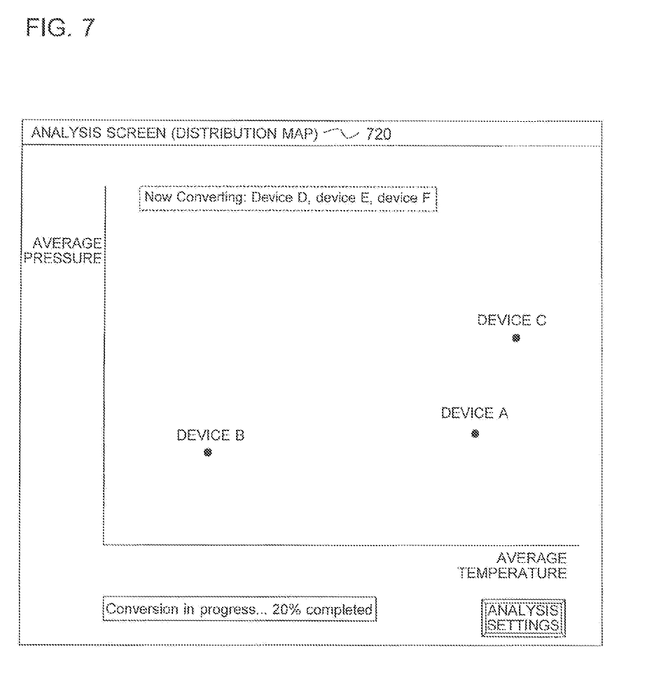

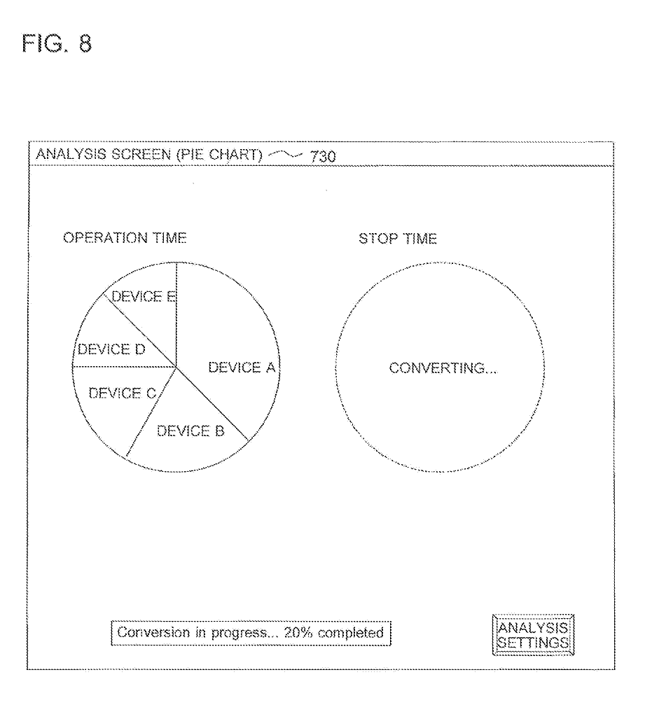

FIGS. 6 to 8 are schematic diagrams (part 2) to (part 4) illustrating the analysis screen 700 of the data analysis information processing device 100, in which FIG. 6 illustrates a bar graph 710, FIG. 7 illustrates a distribution map 720, and FIG. 8 illustrates a pie chart 730. Suitable graph forms for the analysis may be selected. On any analysis screen, data of which a normalization process has been completed is displayed as an analysis result, in the region for displaying the analysis result, and as for data before normalization or data being normalized, a message such as “Converting . . . ”, that is an initial state, is displayed. Further, by displaying a message showing the percentage of the data in which the normalization process has been completed as a numerical value, a more easily recognizable configuration for the operator can be realized. Even in the middle of the analysis, a new item can be set by operating the analysis designation button displayed on the analysis screen. Thereby, data desired by the operator can be provided instantly. It should be noted that on the analysis screen, functions may be added in consideration of the convenience of the operator such as a function of increasing or decreasing the number of items or changing the scale of the display.

In the data analysis information processing device of Embodiment 1 of the present invention as described above, the normalization processing unit 112 normalizes analysis target data based on a notification from the analysis instruction unit 110 (normalization instruction unit 111), and the database processing unit 114 stores it in the database 102. At the same time and in parallel thereto, the database processing unit 114 sequentially visualizes the analysis target data put in a database, based on a notification from the analysis instruction unit 110 (visualization instruction unit 113). Thereby, the analysis target data selected by the operator is compiled into the database and is visualized immediately, without waiting for normalization of whole of the data to be normalized. Since the analysis target data is processed prior to other data as described above, desired data can be visualized quickly and provided to the operator.

### Embodiment 2

A data analysis information processing device 100 according to Embodiment 2 of the present invention will be described. In Embodiment 2, description is mainly given on different points from Embodiment 1. The same parts as those of Embodiment 1 are denoted by the same reference numerals, and the description thereof is omitted. It should be noted that the configuration of the data analysis information processing device 100 according to Embodiment 2 is same as the configuration of the data analysis information processing device 100 of FIG. 1 described in Embodiment 1. Therefore, the description thereof is omitted.

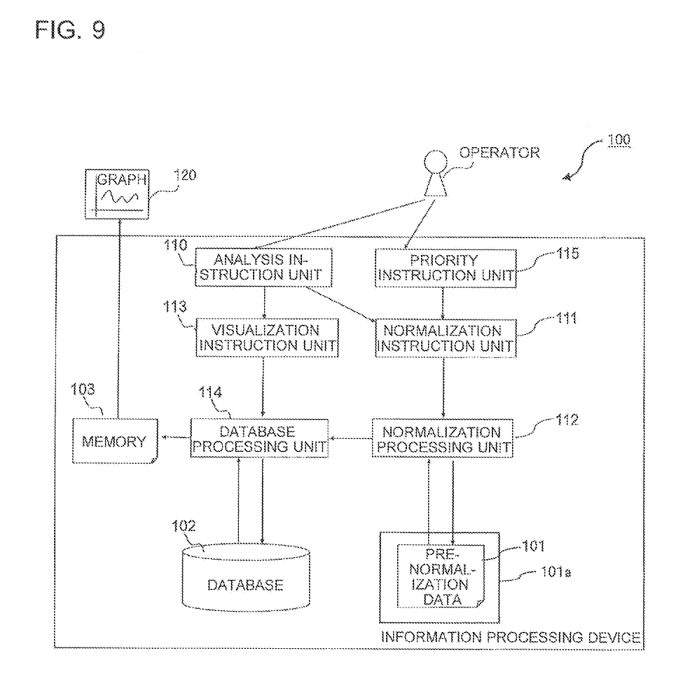

FIG. 9 is a block diagram illustrating the data analysis information processing device 100 according to Embodiment 2 of the present invention. As illustrated in FIG. 9, the data analysis information processing device 100 includes an analysis instruction unit 110 that receives a notification of analysis target data set by an operator, and a priority instruction unit 115 that receives a notification of the priority set by the operator. The analysis instruction unit 110 notifies the normalization instruction unit 111 and the visualization instruction unit 113 of the analysis target data based on the notification, similarly to Embodiment 1. Then, the priority instruction unit 115 determines data, to which a priority is set, as prioritized analysis target data, and notifies it to the normalization instruction unit 111. For example, when “temperature” and “pressure” are designated as analysis item setting 502 among the designated contents, and “temperature” is designated as priority analysis item setting 602, “temperature” is determined to be prioritized analysis target data having a high priority.

The normalization instruction unit 111 notifies the normalization processing unit 112 of the analysis target data notified by the analysis instruction unit 110 and the prioritized analysis target data notified by the priority instruction unit 115. Based on an instruction by the normalization instruction unit 111, the normalization processing unit 112 sequentially extracts the prioritized analysis target data and the analysis target data from the pre-normalization data 101 and normalizes them, and then stores them in the database 102 immediately. Then, similar processing is performed on the remaining pre-normalization data 101 to normalize it and compile it into the database.

The visualization instruction unit 113 instructs visualization of data to the database processing unit 114 based on the notification from the analysis instruction unit 110, similarly to the visualization instruction unit 113 of Embodiment 1. Based on the notification, the database processing unit 114 extracts data after the normalization stored in the database 102, and loads it on the memory 103. Then, the data loaded on the memory 103 is visualized in a graph on the analysis screen.

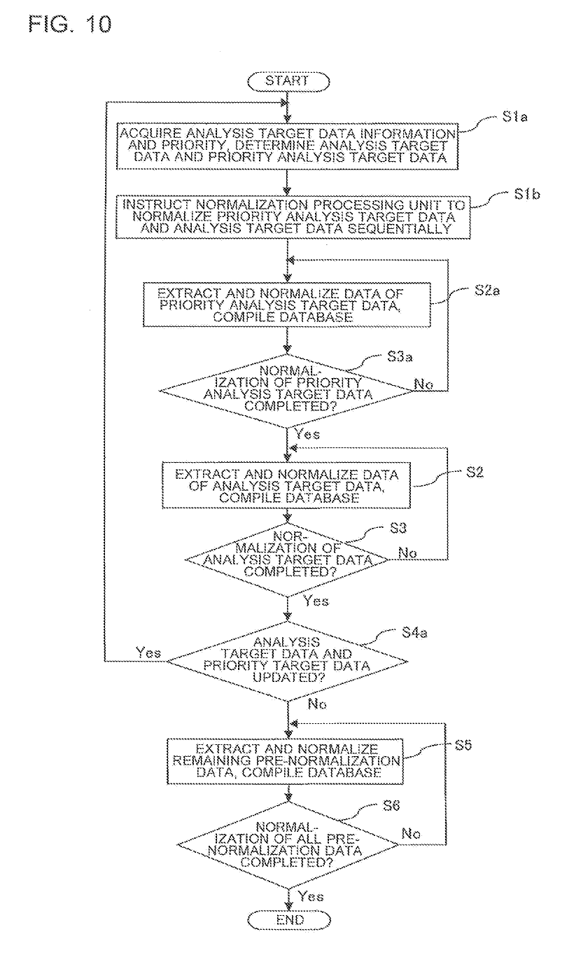

FIG. 10 is a flowchart explaining a normalization process performed by the data analysis information processing device 100 of FIG. 9. As illustrated in FIG. 10, the normalization instruction unit 111 acquires information of analysis target data and a priority, and determines analysis target data and prioritized analysis target data (S1a). Then, the normalization instruction unit 111 issues the instruction for the normalization processing unit 112 to normalize the prioritized analysis target data and the analysis target data in this order (S1b). Next, the normalization processing unit 112 extracts the prioritized analysis target data from the pre-normalization data 101, normalizes it, and stores it in the database 102 (S2a). Then, the normalization processing unit 112 determines whether or not normalization of every prioritized analysis target data is completed (S3a). When it is not completed, the normalization processing unit 112 returns to step S2a, while when it is completed, the normalization processing unit 112 moves to step S2. Next, the normalization processing unit 112 extracts the analysis target data from the pre-normalization data 101, normalizes it, and stores it in the database 102 (S2). Then, it is determined whether or not normalization of every analysis target data is completed (S3). When it is not completed, the process returns to step S2, while when it is completed, the process moves to step S4a. Next, the normalization instruction unit 111 determines whether or not information of the analysis target data or the prioritized analysis target data is updated (S4a). When it is determined that there is one, the process returns to step S1a, while when it is determined that there is none, the process moves to step S5. Then, the normalization processing unit 112 extracts the pre-normalization data 101 not having been normalized, normalizes it, stores it in the database 102 (S5), and determines whether or not normalization of every pre-normalization data 101 is completed (S6). When it is determined that normalization is not completed, the process returns to step S5, while when normalization is completed, the process ends.

As described above, by enabling setting priority to the analysis target data and setting data to be normalized prior to other data of the analysis target data, it is possible to perform analysis according to the analysis priority with respect to a plurality of items of one designated content.

It should be noted that the processing performed by the visualization instruction unit 113 is similar to that of Embodiment 1. The visualization instruction unit 113 sequentially visualizes the analysis target data stored in the database 102. At this time, prioritized analysis target data is sequentially normalized and stored in the database 102. Consequently, prioritized analysis target data is visualized prior to other data. Thereby, it is possible to quickly visualize data that the operator wishes to analyze prior to other data, and provide it.

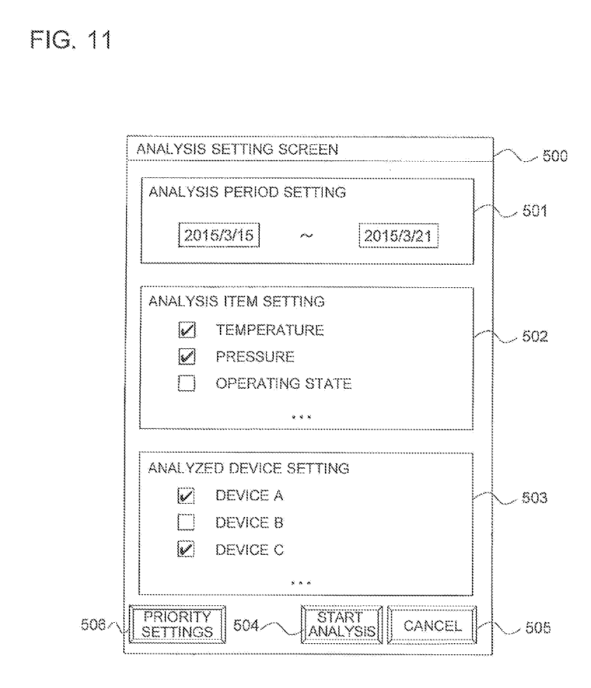

FIG. 11 is a schematic diagram illustrating an analysis setting screen 500 of the data analysis information processing device 100 of FIG. 9. As illustrated in FIG. 11, the analysis setting screen 500 includes a priority designation button 506, in addition to the analysis period setting 501, the analysis item setting 502, the analyzed device setting 503, the analysis start button 504, and the cancel button 505, similarly to Embodiment 1. The priority designation button 506 is provided to select a plurality of items in respective designation items, and designate priority to each of them.

First, the operator inputs an instruction about an analysis target that the operator wishes to analyze prior to other data, on the analysis setting screen 500. For example, the operator sets “2015/3/15˜2015/3/21” in the analysis period setting 501, designates “temperature” and “pressure” in the analysis item setting 502, and designates “device A” and “device C” in the analyzed device setting 503, for example.

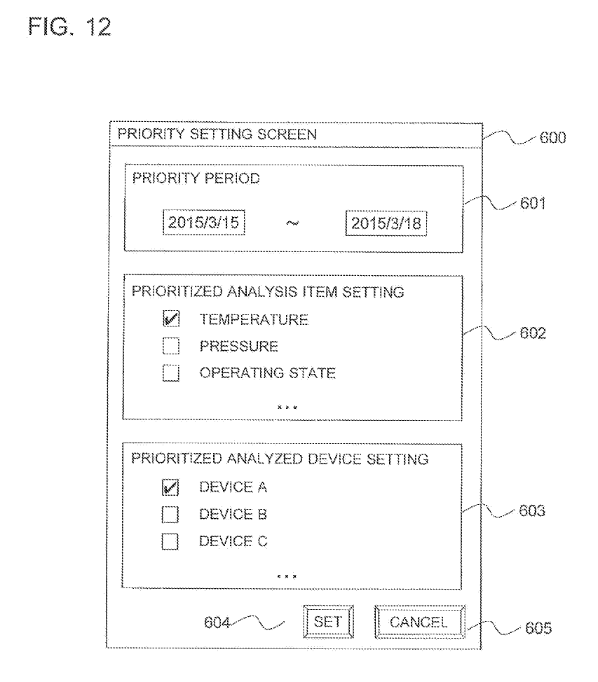

FIG. 12 is a schematic diagram illustrating a priority designation screen 600 of the data analysis information processing device of FIG. 9. As illustrated in FIG. 12, when the operator presses the priority designation button 506 on the analysis setting screen 500, the priority designation screen 600 is displayed. On the priority designation screen 600, the operator sets priority by further designating an item regarding the selected designation contents. The priority designation screen 600 includes items for inputting priority period setting 601, priority analysis item setting 602, and priority analyzed device setting 603, and a designation button 604 and a cancel button 605. The items selected in the priority period setting 601, the priority analysis item setting 602, and the priority analyzed device setting 603 are selected as items to be analyzed higher in priority among the selected items.

When the priority designation screen 600 is displayed, the operator designates items that the operator wishes to analyze prior to other data. For example, the operator sets “2015/3/15˜2015/3/18” in the priority period setting 601, designates “temperature” in the priority analysis item setting 602, and designates “device A” in the priority analyzed device setting 603. Thereby, analysis corresponding to the designated items in the designated period is performed prior to other data.

Then, when the operator presses the designation button 604, the designated item is set as analysis target data having the highest priority. When the cancel button 605 is pressed, none of the items are set as items having the highest priority. When the designation button 604 or the cancel button 605 is pressed, the screen is returned to the analysis setting screen 500 from the priority designation screen 600.

Then, when the analysis start button 504 is pressed on the analysis setting screen 500, an item that is to be normalized prior to other data is notified from the analysis instruction unit 110 and the priority instruction unit 115 to the normalization processing unit 112. As a result, the analysis target data, for which priority is set, is normalized prior to other data, then, analysis target data is normalized, and then, the other data are normalized, and the normalized data are sequentially displayed on the analysis screen.

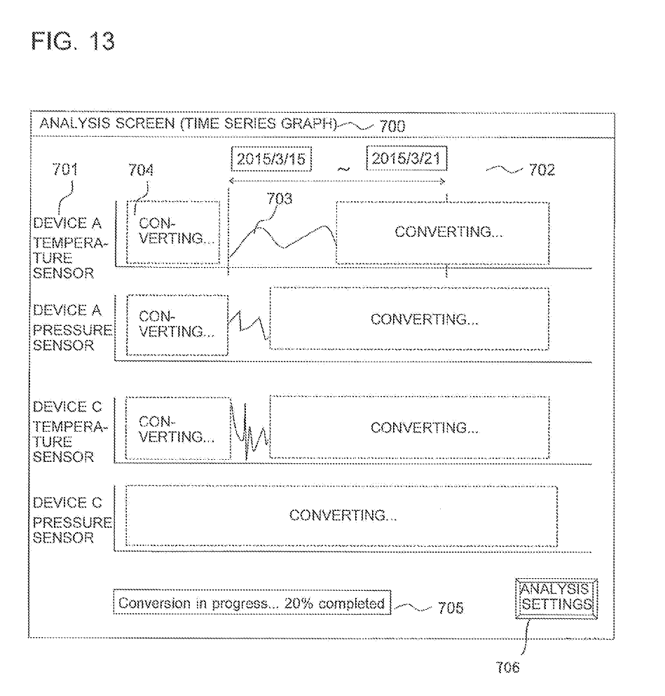

FIG. 13 is a schematic diagram illustrating an analysis screen 700 of the data analysis information processing device 100 of FIG. 10. As illustrated in FIG. 13, on the analysis screen 700, the designated contents set on the analysis setting screen 500 are displayed, similarly to Embodiment 1. Then, in the visualized data, the contents set on the priority designation screen 600 are displayed prior to other data. Further, the data is regularly updated. As the time passes, the percentage of the visualized data increases, and finally, whole of the data is displayed. Thereby, it is possible to quickly visualize data desired by the operator and provide it.

It should be noted that in the above example, two units of analysis target data are selected, and priority is set to one of them. However, the number of units of analysis target data is not limited. For example, it is possible to have a configuration in which priority is set to each of the selected units of analysis target data, and displaying the units of analysis target data are displayed sequentially according to the priority.

In the data analysis information processing device according to Embodiment 2 of the present invention described above, by selecting a plurality of units of analysis target data and enabling priority setting to the analysis target data, it is possible to further set priority to the data that the operator wishes to perform analysis with the highest priority, among the units of analysis target data. Thereby, the operator can obtain a desired analysis result more quickly. It should be noted that setting of the priority is not limited to two stages. Priority may be set in three stages or more.

### Embodiment 3

A data analysis information processing device according to Embodiment 3 of the present invention will be described. In Embodiment 3, description is mainly given on different points from Embodiments 1 and 2. The same parts as those of Embodiments 1 and 2 are denoted by the same reference numerals, and the description thereof is omitted. Embodiment 3 differs from Embodiments 1 and 2 in that an analysis processing unit performs analysis and processing of data based on an instruction by an analysis instruction unit.

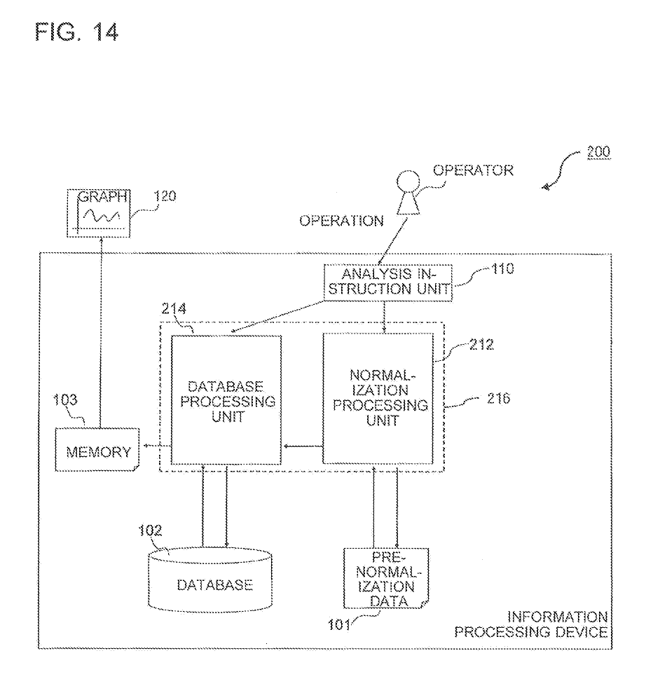

FIG. 14 is a block diagram illustrating a data analysis information processing device 200 according to Embodiment 3 of the present invention. As illustrated in FIG. 14, the data analysis information processing device 200 includes the analysis instruction unit 110 that specifies analysis target data and issues instruction, an analysis processing unit 216 that analyzes and processes the instructed analysis target data, and the memory 103 in which the processed data is loaded for visualization. The analysis processing unit 216 is configured of a normalization processing unit 212 and a database processing unit 214. The data loaded in the memory 103 is displayed on the display device 120.

The analysis instruction unit 110 specifies data of an item set by an operator as an item that the operator wishes to analyze prior to other data, to be analysis target data, and specifies it. Then, the analysis instruction unit 110 instructs each of the normalization processing unit 212 and the database processing unit 214 of the analysis processing unit 216, of the analysis target data to be analyzed prior to other data.

The normalization processing unit 212 performs processing to normalize the analysis target data prior to other data, according to the instruction by the analysis instruction unit 110. The normalization processing unit 212 extracts the analysis target data from the pre-normalization data 101 prior to other data, normalizes the pre-normalization data 101 sequentially, and provides the normalized data to the database processing unit 214 successively.

The database processing unit 214 performs processing to store the data received from the normalization processing unit 212 in the database 102, and at the same time, extracts data stored in the database 102 for visualization and loads it in the memory 103, according to the instruction by the analysis instruction unit 110. In the database 102, the data received from the normalization processing unit 212 is stored successively in the received order. In the memory 103, analysis target data extracted prior to other data according to the instruction by the analysis instruction unit 110 is loaded in the order extracted.

The data is loaded successively in the memory 103, visualized in the display device 120, and is displayed in a graph, for example.

The normalization processing unit 212 and the database processing unit 214 perform normalization of data and database compilation for visualization as a series of processing simultaneously in parallel. This means that the analysis instruction unit 110 has a function corresponding to the normalization instruction unit 111 instructing normalization and a function corresponding to the visualization instruction unit 113 instructing visualization.

Next, a normalization process performed by the data analysis information processing device 200 will be described. When analysis is started, analysis target data is notified from the analysis instruction unit 110 to the analysis processing unit 216, and is notified from the analysis processing unit 216 to each of the normalization processing unit 212 and the database processing unit 214. In the normalization processing unit 212, the analysis target data is extracted prior to other data from the pre-normalization data 101 and normalized based on the notification, and provided to the database processing unit 214. At the same time, in the database processing unit 214, the analysis target data is extracted prior to other data from the database 102 in which the normalized data is stored, and is loaded in the memory 103. Then, the analysis target data is visualized in the memory 103, and is displayed on the display device 120. When analysis of the analysis target data is completed, data other than the analysis target data is sequentially extracted by the normalization processing unit 212 and the database processing unit 214, and is analyzed. Then, the analyzed data is sequentially displayed on the display device 120, whereby the display is enriched.

As described above, the normalization processing unit 212 and the database processing unit 214 normalize the data extracted based on the instruction by the analysis instruction unit 110 and compile it in a database simultaneously in parallel as a series of processing. Thereby, data that the operator wishes to analyze prior to other data is processed prior to other data. Accordingly, data that the operator wishes to analyze prior to other data, that is, desired data, is visualized quickly.

It should be noted that in the description provided above, the configuration in which the analysis instruction unit 110 instructs normalization and visualization has been described. However, a configuration in which each of the normalization processing unit 212 and the database processing unit 214 has a function of instructing normalization and a function of instructing visualization is also acceptable. For example, a configuration is applicable in which analysis target data is instructed by the analysis instruction unit 110, and that a visualization instruction unit having a function of instructing a database processing unit to visualize the analysis target data, based on the instruction, is also provided. In this configuration, the database processing unit 214 performs visualization according to the instruction by the visualization instruction unit, and the analysis target data is loaded prior to other data in the memory 103 and is displayed on the display device 120.

### Modification of Embodiment 3

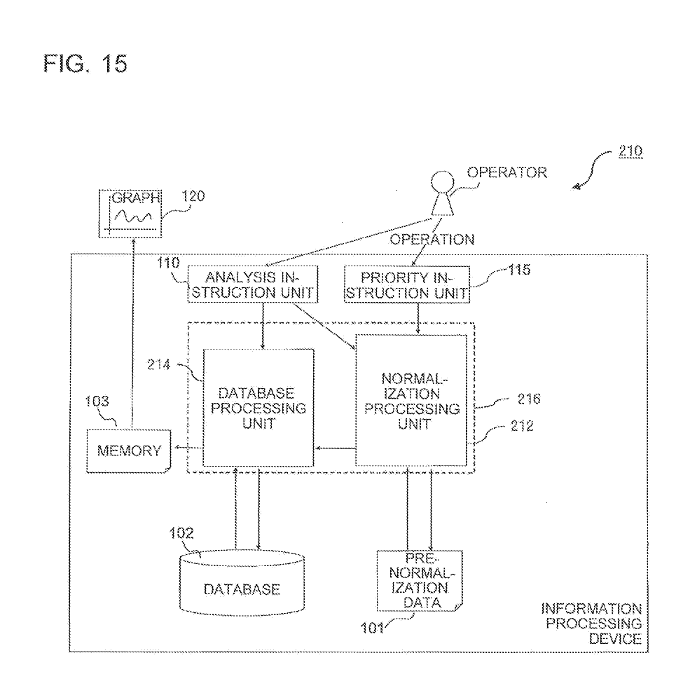

FIG. 15 is a block diagram illustrating a data analysis information processing device 210 according to a modification of Embodiment 3 of the present invention. As illustrated in FIG. 15, the data analysis information processing device 210 according to the modification is different in that a priority instruction unit 115 that designates priority of analysis target data is provided, in addition to the analysis instruction unit 110 that designates the analysis target data.

When an operator selects analysis target data that the operator particularly wishes to analyze prior to other data of the analysis target data set as an item to be analyzed prior to other data, the priority instruction unit 115 sets priority to the analysis target data based on the selection. The priority instruction unit 115 instructs the analysis processing unit 216 of the priority of the analysis target data.

When the instruction of the priority is given from the priority instruction unit 115 to the analysis processing unit 216, the normalization processing unit 212 extracts, prior to other data, data of higher priority, of the analysis target data designated by the analysis instruction unit 110, from the pre-normalization data 101, and performs a normalization process.

With this configuration, even when there are a plurality of units of analysis target data, it is possible to determine priority in the analysis target data and perform analysis prior to other data. Thereby, it is possible to visualize data desired by the operator more quickly and provide it.

It is also acceptable to have a configuration in which an instruction of priority by the priority instruction unit 115 is notified to the database processing unit 214 at the same time as the analysis processing unit 216. With this configuration, in the case where there are a plurality of units of analysis target data, not displayed on the display device 120, in the database processing unit 214, data to be extracted is determined based on the priority. Accordingly, it is possible to provide desired data to the operator more quickly.

As described above, the data analysis information processing device 200 according to Embodiment 3 of the present invention includes the analysis instruction unit 110 that designates analysis target data, the analysis processing unit 216 that analyzes the analysis target data, and the display device 120 that displays the analysis target data sequentially and gradually. With the instruction by the analysis instruction unit 110, an instruction of normalization and an instruction of visualization of the analysis target data are directly notified to the normalization processing unit 212 and the database processing unit 214 of the analysis processing unit 216, respectively. Thereby, the data transmission channel is simplified, and the data is displayed more quickly.

Further, the data analysis information processing device 200 according to Embodiment 3 of the present invention further includes the database 102 that stores normalized data, and the memory 103 that stores data to be displayed on the display device 120. The analysis processing unit 216 is configured of the normalization processing unit 212 that normalizes, prior to other data, analysis target data, and the database processing unit 214 that stores data in a database, extracts the analysis target data prior to other data, and loads it in the memory. Then, the data loaded in the memory 103 is displayed on the display device 120. Thereby, the channel through which an instruction of data is transmitted can be simplified.

Further, the data analysis information processing device 200 according to Embodiment 3 of the present invention includes a visualization instruction unit that instructs visualization of data designated by the analysis instruction unit 110. The visualization instruction unit issues instructions to visualize, prior to other data, the analysis target data designated by the analysis instruction unit 110, and the database processing unit 214 extracts, prior to other data, the data designated by the visualization instruction unit 113 and loads it in the memory 103. Thereby, in the case of a large amount of data, a plurality of channels through which an instruction of data is transmitted are constructed. Thereby, the data processing speed is improved, and the data desired by the operator is provided quickly.

Further, the data analysis information processing device 200 according to Embodiment 3 of the present invention further includes the priority instruction unit 115 by which priority is set to the analysis target data. According to an instruction by the priority instruction unit 115, analysis target data of higher priority is displayed prior to other data sequentially and gradually. Thereby, the operator can set priority of the analysis target data to be displayed in more detail, and acquire an analysis result of the desired analysis target data.

### Embodiment 4

A data analysis information processing device according to Embodiment 4 of the present invention will be described. In Embodiment 4, description is mainly given on different points from Embodiments 1 to 3. The same parts as those of Embodiments 1 to 3 are denoted by the same reference numerals, and the description thereof is omitted. Embodiment 4 differs from Embodiments 1 to 3 in aspects of an analysis screen and an analysis setting screen to be displayed on the display device 120.

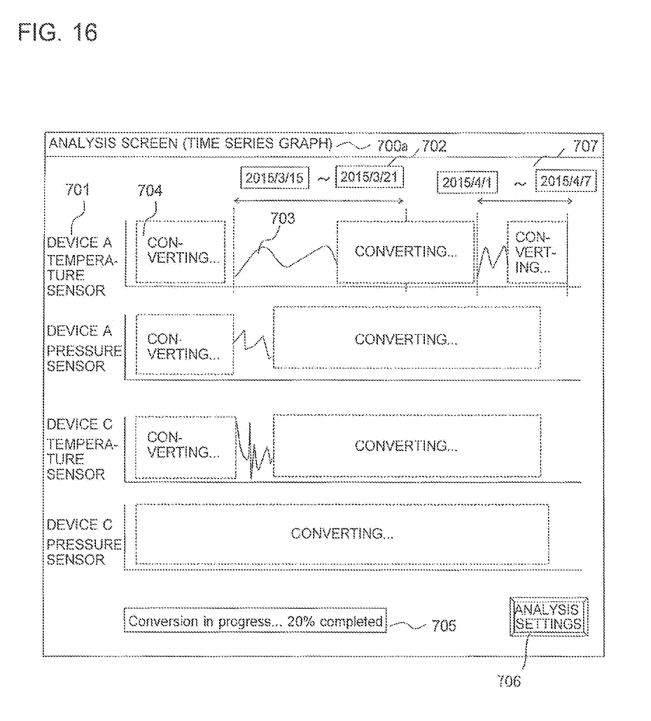

FIG. 16 is a schematic diagram illustrating an analysis screen 700a of a data analysis information processing device according to Embodiment 4 of the present invention. FIG. 16 illustrates the case where the analysis period setting 501 is reset in the middle of analysis, for example. As illustrated in FIG. 16, on the analysis screen 700a, devices and sensors information 701, analysis period 702, and analyzed data including visualized analysis target data are displayed. The analysis target data is displayed on the analysis screen 700a in a graph 703 such as a time-series line graph, with the message 704 such as “Converting . . . ” being provided between the graphs. On the analysis screen 700a, the progress indicator 705 showing the percentage of the analysis progress is also displayed. It should be noted that the message 704 is an example of information indicating that analysis of the present invention is not completed. Further, the progress indicator 705 is an example indicating the level of progress of the present invention.

The analysis screen 700a is divided into regions each showing the sensor information 701 of a device that performs designated analysis. The message 704 indicating that analysis is not completed and the graph 703 such as a line graph are displayed on each region in a non-time-series manner. It should be noted that the regions in the analysis screen 700a are examples of first and second display regions of the present invention.

When the data analysis information processing device starts analysis, data is normalized and stored in the database 102 sequentially, and the data stored in the database 102 is successively loaded in the memory 103 for visualization. Immediately after the start of analysis, as there is no normalized data in the database 102, the memory space is set in an initial state. In this case, the memory 103 causes the display device 120 to display the message 704 of information such as “Converting . . . ” indicating that analysis is not completed.

Along with the progress of the analysis, the analysis target data to be analyzed prior to other data is extracted from the data before normalization, and is normalized by the analysis processing unit 216. At the same time, by the database processing unit 214, normalized data is stored in the database 102 sequentially, and is extracted from the database 102. The data extracted by the database processing unit 214 is replaced with the memory space set in the initial state in the memory 103, and is loaded to be visualized. The visualized data is displayed by the display device 120 in place of the message 704 in the region where the message 704 indicating information that analysis is not completed is displayed on the analysis screen 700a. As normalization and visualization of data are performed independently in parallel, the analysis target data is displayed sequentially and the display is enriched gradually.

For example, when the operator operates to change analysis target data to new data in the middle of the analysis, the analysis instruction unit 110 instructs the analysis processing unit 216 of the analysis target data after the change. Based on such an instruction, the analysis processing unit 216 extracts analysis data after the change from the data before normalization, and performs normalization. At the same time, the database processing unit 214 stores the normalized data in the database 102, and extracts, prior to other data, the analysis target data after the change from the database 102 and provides it to the memory 103. When the data is visualized by the memory 103, the analysis target data after the change is displayed prior to other data. At this time, when the analysis target data after the change is data in a region apart from time series, for example, the analysis target data after the change is displayed with the display of “Converting . . . ”, indicating that analysis is not completed, between it and the analysis target data before the change.

Then, when display of the analysis target data is completed, analysis of other data progresses. When analysis of whole of the data is completed, it is displayed in a graph or the like, and analysis of the data ends.

According to the data analysis information processing device according to Embodiment 4 of the present invention, information indicating that analysis is not completed, such as the message 704 of “Converting . . . ”, is displayed until the analysis target data is analyzed, on the display device 120. Thereby, it is possible to inform the operator of the data under conversion.

Further, according to the data analysis information processing device according to Embodiment 4 of the present invention, the message 704 indicating information that analysis is not completed is displayed on the region where analyzed analysis target data is to be displayed when the analysis target data is analyzed. As such, the operator can predict that the analysis target data will be displayed on such a region in time.

Further, according to the data analysis information processing device according to Embodiment 4 of the present invention, the message 704 indicating information that analysis is not completed is displayed on a plurality of locations of the display device 120. As such, data in which analysis is completed is displayed successively, and data desired by the operator can be displayed in preference to other data.

Further, according to the data analysis information processing device according to Embodiment 4 of the present invention, when the specified analysis target data is changed, the changed analysis target data is analyzed prior to other data sequentially and gradually, and is displayed on the display device 120. Thereby, it is possible to promptly analyze the data that the operator desires most and display it at any point of time.

Further, according to the data analysis information processing device according to Embodiment 4 of the present invention, analyzed analysis target data is displayed with the message 704 indicating information that analysis is not completed being provided before it. In this way, even when analysis of the analysis target data before the change is not completed, as analysis target data after the change is displayed prior to other data, it is possible to analyze the data that the operator desires most quickly and display it.

Further, according to the data analysis information processing device according to Embodiment 4 of the present invention, the display device 120 includes a plurality of display regions, and different data is to be displayed in each region. Thereby, it is possible to quickly display an analysis result of a device desired by the operator at desired priority.

### Embodiment 5

A data analysis information processing device according to Embodiment 5 of the present invention will be described. In Embodiment 5, description is mainly given on different points from Embodiments 1 to 4. The same parts as those of Embodiments 1 to 4 are denoted by the same reference numerals, and the description thereof is omitted. Embodiment 5 shows another aspect of the analysis screen 700 displayed on the display device.

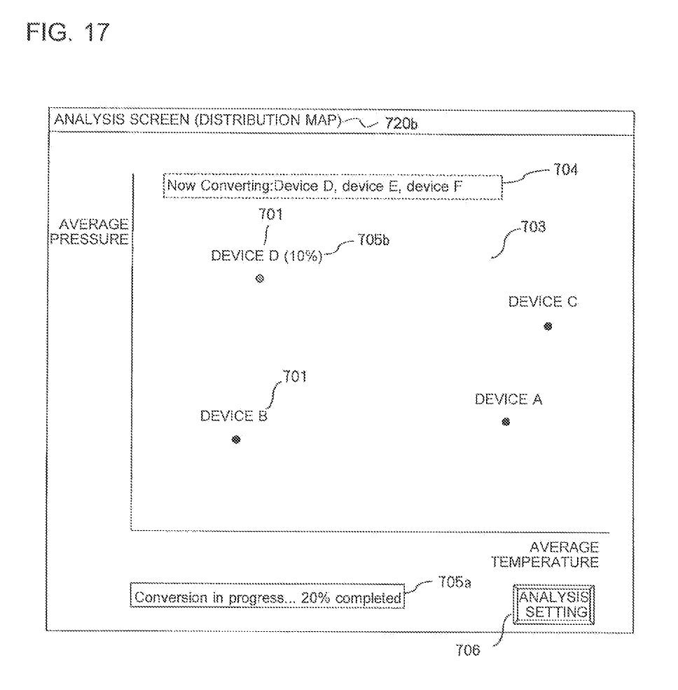

FIG. 17 is a schematic diagram (part 5) illustrating an analysis screen 720b of the data analysis information processing device according to Embodiment 5 of the present invention. As illustrated in FIG. 17, the display device 120 displays analyzed data on the analysis screen 720b.

On the analysis screen 720b, a distribution map 720, including sensor information 701 indicating each device and a message 704 indicating that analysis is not completed regarding such a device, is displayed. On the analysis screen 720b, as indications showing the progress of analysis in a distribution map or the like, a progress indicator 705a showing the percentage of data in which analysis is completed relative to the entire data, and a progress indicator 705b showing the progress of data analysis in each device in which analysis is being performed, are displayed. The progress indicator 705b is displayed near the sensor information 701 showing the device that the progress indicator 705b shows the progress. In the lower part of the analysis screen 720b, the analysis designation button 706, to be pressed when the operator wishes to set new analysis target data, is displayed. The display content displayed on the analysis screen 720b is updated successively, and on the progress indicators 705a and 705b showing the progress of the data analysis, the progress at each point of time is displayed.

In the graph 703, the sensor information 701 of each of the devices A, B, and C is displayed by a black spot at a region corresponding to the analyzed result. On the other hand, regarding the device D in which analysis is being performed, the percentage indicating the progress of analysis is displayed by a gray spot, along with the sensor information 701. Regarding the devices E and F in which analysis has not started, they are displayed in the message 704 as an indication that analysis is not completed. Regarding the devices in which analysis is being performed, the progress indicator 705b showing the progress of analysis is updated successively. At the same time, the gray spot is displayed to be darker, whereby the visibility is improved.

From the graph 703, the operator is able to read that the device D in which analysis is being performed currently is recognized, the progress of the analysis in the device D shown by a gray dot is 10%, and analysis has not started in the devices E and F, along with the results of the analyzed devices A, B, and C. By displaying the aspects each having the meaning on the analysis screen 700, it is possible to show the progress of analysis in each device and the progress of analysis of the entire data can be displayed as information indicating that analysis is not completed.

According to the data analysis information processing device according to Embodiment 5 of the present invention, information indicating that analysis is not completed includes the progress indicator 705 showing information related to the progress of analysis of the analysis target data. Thereby, the operator can easily grasp the analysis result, and the convenience of the operator is improved.

Further, according to the data analysis information processing device of Embodiment 5 of the present invention, as the progress indicator 705 showing the progress of analysis is updated successively, the latest information is always provided to the operator. Thereby, the operator can instantly obtain the analysis result, and it is possible to prevent the operator from feeling discomfort to wait for the analysis result.

### Embodiment 6

A data analysis information processing device according to Embodiment 6 of the present invention will be described. In Embodiment 6, description is mainly given on different points from Embodiments 1 to 5. The same parts as those of Embodiments 1 to 5 are denoted by the same reference numerals, and the description thereof is omitted. Embodiment 6 shows other forms of an analysis setting screen and a priority designation screen displayed on the display device.

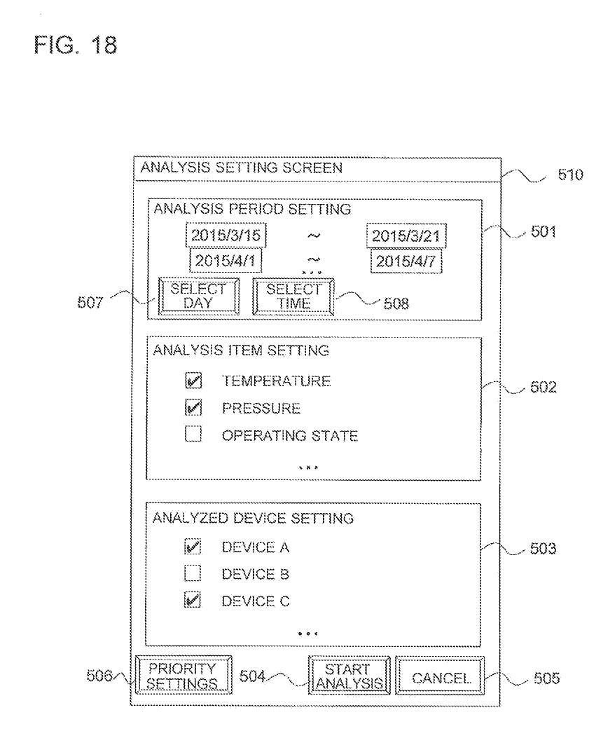

FIG. 18 is a schematic diagram of an analysis setting screen 510 of a data analysis information processing device according to Embodiment 6 of the present invention. As illustrated in FIG. 18, the analysis setting screen 510 displayed on the display device 120 configured of a touchscreen or the like includes the analysis period setting 501, the analysis item setting 502, and the analyzed device setting 503, and respective items are set by operation by an operator. The analysis setting screen 510 also includes the priority designation button 506, the analysis start button 504, the cancel button 505, and the like.

In the analysis period setting 501, an operator sets a plurality of desired analysis periods. In the case of setting execution of analysis on a particular day and time within the set period, day selection 507 and time selection 508 are operated. In the analysis item setting 502, the operator selects items such as time, pressure, and an operation state desired by the operator, and designates a device that the operator wishes to use it for analysis in the analyzed device setting 503.

Thereby, 2015/3/15˜2015/3/21 and 2015/4/1˜2015/4/7 are set in the analysis period setting 501, temperature and pressure are designated in the analysis item setting 502, and a device A and a device C are designated in the analyzed device setting 503, for example.

When designation on the analysis setting screen 510 is completed, any of the priority designation button 506, the analysis start button 504, and the cancel button 505 is operated.

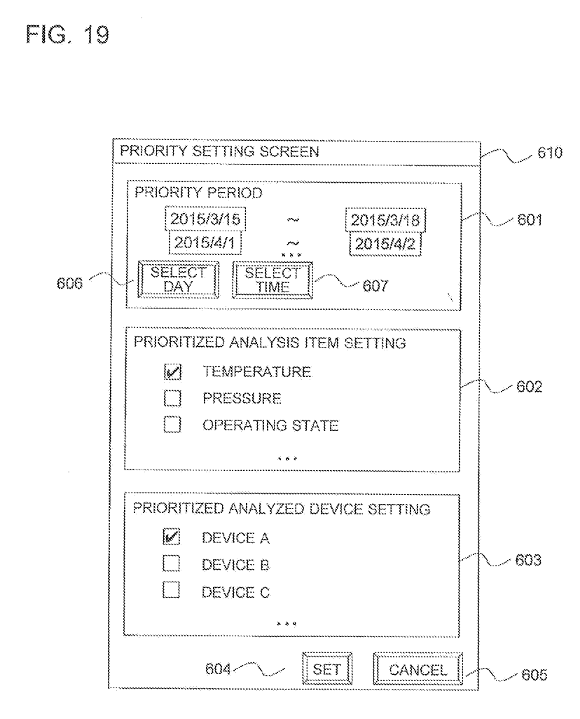

FIG. 19 is a schematic diagram illustrating a priority designation screen 610 of a data analysis information processing device according to Embodiment 6 of the present invention. The priority designation screen 610 is displayed in place of the analysis setting screen 510 when the priority designation button 506 is operated on the analysis setting screen 510. As illustrated in FIG. 19, the priority designation screen 610 includes the priority period setting 601, the priority analysis item setting 602, and the priority analyzed device setting 603. On the priority designation screen 610, priority is set to an item in which analysis is to be performed prior to other data, by the operation by the operator. The priority designation screen 610 also includes the designation button 604 and the cancel button 605.

In the priority period setting 601, a priority period is set particularly when there is a period for which analysis is to be performed prior to other data in the designated analysis period setting 501. When there are a plurality of priority periods, a plurality of periods can be set. In the case of setting execution of analysis to a particular day and time in the set priority period, day selection 606 and time selection 607 are operated.

In the priority analysis item setting 602, an item in which analysis is to be performed prior to other data, among the items to be analyzed set in the analysis item setting 502, is selected. Further, in the priority analyzed device setting 603, an item in which analysis is to be performed prior to other data, among the devices set in the analyzed device setting 503, is selected.

Thereby, 2015/3/15˜2015/3/18 and 2015/4/1˜2015/4/2 are set in the priority period setting 601, temperature is designated in the priority analysis item setting 602, and the device A is designated in the priority analyzed device setting 603, for example.

When designation on the priority designation screen 610 is completed, the designation button 604 for fixing the designated content or the cancel button 605 for canceling the set is operated, and the analysis setting screen 510 is displayed again on the display device 120.

As described above, on the analysis setting screen 510 and the priority designation screen 610, it is possible to specify the analysis target data in detail by increasing the display items. Accordingly, it is possible to quickly provide information matching the operator's request to the operator.

It should be noted that the respective items displayed on the analysis setting screen 510 and the priority designation screen 610 are not limited to those described above. The contents and the number thereof can be changed according to the analysis target. Further, a configuration of giving further priority in stages such as low, intermediate, and high, is also acceptable.

### REFERENCE SIGNS LIST

100, 200, 210 data analysis information processing device 101 pre-normalization data 101a memory 102 database 103 memory 110 analysis instruction unit 111 normalization instruction unit 112, 212 normalization processing unit 113 visualization instruction unit 114, 214 database processing unit 115 priority instruction unit 120 display device

216 analysis processing unit 300 analysis screen 500, 510 analysis setting screen 501 analysis period setting 502 analysis item setting

503 analyzed device setting 504 analysis start button 505 cancel button 506 priority designation button 507 day selection 508 time selection 600, 610 priority designation screen 601 priority period setting

602 priority analysis item setting 603 priority analyzed device setting

604 designation button 605 cancel button 606 day selection

607 time selection 700, 700a, 720b analysis screen 701 sensor information 702 analysis period 703 graph 704 message 705, 705a, 705b progress indicator 706 analysis designation button 710 bar graph

720 distribution map 730 pie chart.

1. A data analysis information processing device comprising:
a database configured to store normalized data;
a memory configured to store part of the data of the database;
an analysis instruction unit configured to specify analysis target data, to be analyzed prior to other data, of data before normalization, and designate the analysis target data;
a normalization instruction unit configured to issue instruction to perform processing to normalize, prior to other data, the analysis target data designated by the analysis instruction unit;
a visualization instruction unit configured to issue instruction to perform processing to visualize, prior to other data, the analysis target data designated by the analysis instruction unit;
a normalization processing unit configured to normalize, prior to other data, the analysis target data of the data before normalization;
a database processing unit configured to store the data normalized by the normalization processing unit to the database, extracts, prior to other data, data designated by the visualization instruction unit from the database, and load the extracted data in the memory; and
a display device configured to display the data loaded in the memory.

2. The data analysis information processing device of claim 1, further comprising
a priority instruction unit configured to set a priority to the analysis target data specified by the analysis instruction unit.

3. The data analysis information processing device of claim 2, wherein
the normalization processing unit first normalizes the data to which a higher priority is set.

4. The data analysis information processing device of claim 1, wherein
a series of processing to normalize data by the normalization processing unit and store the data in the database by the database processing unit and a series of processing to extract data from the database and load the data in the memory by the database processing unit are performed in parallel.

5. The data analysis information processing device of claim 1, wherein
the database processing unit is configured to repeatedly perform extraction and loading of the data periodically.

6. The data analysis information processing device of claim 1, wherein
when the analysis instruction unit changes the analysis target data to be analyzed prior to other data in middle of a normalization process performed by the normalization processing unit, the normalization instruction unit and the visualization instruction unit each set the changed analysis target data as data to be processed prior to other data.

7. The data analysis information processing device of claim 1, wherein
the analysis target data in the analysis instruction unit is specified by an operator.

8. A data analysis information processing device that processes data, the device comprising:
an analysis instruction unit configured to specify analysis target data to be analyzed prior to other data of the data, and designates the analysis target data;
an analysis processing unit configured to analyze, prior to other data, the analysis target data designated by the analysis instruction unit;
a database configured to store the data that is normalized,
a memory configured to store the normalized data in the database, and
a visualization instruction unit configured to issue instruction to perform processing to visualize the data designated by the analysis instruction unit, and
a display device configured to display the analysis target data analyzed by the analysis processing unit, wherein
the analysis processing unit includes
a normalization processing unit configured to, prior to other data, normalize the analysis target data designated by the analysis instruction unit, and
a database processing unit configured to perform processing to store the data normalized by the normalization processing unit to the database, extract, prior to other data, the analysis target data from the database, and load the extracted data in the memory, and
when the analysis target data is designated by the analysis instruction unit,
the visualization instruction unit instructs the database processing unit to perform processing to visualize, prior to other data, the analysis target data, and
the database processing unit performs processing to store the data normalized by the normalization processing unit to the database, and processing to extract, prior to other data, the data designated by the visualization instruction unit from the database and load the extracted data in the memory, and
the display device displays the data loaded in the memory.

9-10. (canceled)

11. The data analysis information processing device of claim 8, further comprising
a priority instruction unit configured to set a priority to the analysis target data, wherein
on the display device, the analysis target data having a higher priority is displayed, prior to other data, sequentially and gradually according to an instruction by the priority instruction unit.

12. The data analysis information processing device of claim 8, wherein
the display device displays information indicating that analysis is not completed until the analysis target data is analyzed.

13. The data analysis information processing device of claim 12, wherein
the information indicating that analysis is not completed is displayed on a region where the analysis target data that is analyzed is to be displayed when the analysis target data is analyzed.

14. The data analysis information processing device of claim 12, wherein
the information indicating that analysis is not completed is displayed on a plurality of locations on the display device.

15. The data analysis information processing device of claim 8, wherein
when the specified analysis target data is changed,
the display device displays, prior to other data, the changed analysis target data sequentially and gradually.

16. The data analysis information processing device of claim 12, wherein
units of the analysis target data that is analyzed are displayed while the information indicating that analysis is not completed is positioned between the units of the analysis target data.

17. The data analysis information processing device of claim 8, wherein
the display device includes a first display region, and a second display region that is a region different from the first display region,
the data displayed on the first display region and the data displayed on the second display region are different.

18. The data analysis information processing device of claim 12, wherein
the information indicating that analysis is not completed includes information regarding progress of analysis of the analysis target data.

19. The data analysis information processing device of claim 18, wherein
the information regarding the progress is updated.
